(19) United States
(12) Patent Application Publication
(10) Pub. No.: US 2015/0187148 A1
(43) Pub. Date: Jul. 2, 2015

(54) DEVICE AND METHOD FOR ASSISTING WITH RECONFIGURATION OF AN AIRCRAFT, AIRCRAFT INCLUDING SUCH A DEVICE AND ASSOCIATED COMPUTER PROGRAM PRODUCT

(71) Applicant: THALES, NEUILLY SUR SEINE (FR)

(72) Inventors: Christian SANNINO, TOULOUSE (FR); Xavier CHAZOTTES, TOULOUSE (FR); Francois COULMEAU, TOULOUSE (FR)

(21) Appl. No.: 14/565,871

(22) Filed: Dec. 10, 2014

(30) Foreign Application Priority Data
Dec. 11, 2013 (FR) 1302908

(51) Int. Cl. G07C 5/08; B64D 45/00

(52) U.S. Cl. CPC G07C 5/0808; G07C 5/0841; B64D 45/00; B64D 2045/0085

(57) ABSTRACT

A device and method for assisting with reconfiguration of an aircraft, an aircraft including such a device and an associated computer program product are disclosed. In one aspect, the aircraft has an operational configuration, is configured to move in an operational environment, and includes at least one avionic system, at least one avionic member, and at least one monitoring system configured to detect an abnormality of an avionic member or a perturbation of the operational environment and to generate a fault information. The device is connected between at least one monitoring system and at least one avionic system, and includes a reception module configured to receive a fault information from the monitoring system, an impact computation module configured to compute an impact on the operational configuration of the aircraft, and a transmission module configured to transmit the computed impact to at least one avionic system.

### BACKGROUND

1. Field

The described technology generally relates to a device for assisting with reconfiguration of an aircraft. The aircraft having an operational configuration at a given instant, changing in an operational environment and including at least one avionic system, at least one avionic member, the avionic member being connected to at least one avionics system for piloting the aircraft, and at least one monitoring system able to detect an abnormality of at least one avionic member or a perturbation of the operational environment and to generate fault information relating to this abnormality or this perturbation.

The described technology also generally relates to an aircraft including such a device for assisting with reconfiguration.

The described technology also generally relates to a method for assisting with reconfiguration of an aircraft.

The described technology also generally relates to a computer program product including software instructions which, when applied by a piece of computer equipment, applies such a method.

An aircraft as used herein generally refers to any piloted machine capable of flying in at least the Earth's atmosphere, such as an airplane or a helicopter for example.

2. Description of the Related Art

An avionic system as used herein generally refers to any hardware or software means able to be controlled by the pilot or by any other operator or by another avionic system for operating the aircraft. An example of such an avionic system is an automatic pilot, the latter being loaded on board many present aircraft. This automatic pilot generally ensures at least one portion of the piloting of the aircraft according to instructions introduced beforehand by the pilot of the aircraft.

Operation of the aircraft as used herein generally refers to the whole of the parameters which form the mission of the aircraft. This may be the transport of passengers between two airports, a search for persons during an emergency mission, etc.

An avionic member as used herein generally refers to any hardware or software means intended to be used by an avionic system in order to make the operation of the aircraft possible. Each avionic member is then able to provide at least one service to at least one avionic system for operating the aircraft. An example of such a member is the elevator. The automatic pilot for example controls the elevator in order to ensure at least partly stabilization of the aircraft in the vertical plane. Such a stabilization is then considered as a service provided by the elevator to the automatic pilot.

Operational configuration of the aircraft as used herein generally refers to a set of parameters of different members and avionic systems engaged at a given instant during the operation of the aircraft including the mission of the actual aircraft.

An abnormality as used herein generally refers to any event generated when an expected service is not provided.

An operational environment of the aircraft generally refers to the whole of the information forming:
its mission, for example for a commercial airliner its flight plan,
the environmental conditions, such as weather, this information being provided for example by the weather monitoring radar, and by weather information broadcasted by the administrations responsible for this broadcasting, and
air traffic around the aircraft.

A perturbation as used herein generally refers to any state of the operational environment of the aircraft which may negatively act on the operation of the aircraft, these may be weather perturbations, emergency diversion, unexpected traffic of other aircraft, etc.

An impact as used herein generally refers to any change in the operation of the aircraft caused by an abnormality, or a perturbation.

In the field of operating aircraft, the possibility of detecting an abnormality of an avionic member, or of perceiving a perturbation, plays a major role. The knowledge of such an abnormality or perturbation often allows the pilot or any other operator of the aircraft to determine the impact of this abnormality or perturbation on another avionic member and/or on an avionic system and/or on the operation of the aircraft in general.

In this case, the pilot or the operator should be capable of applying a predetermined procedure and/or make a decision according to his/her own experience allowing reduction of this impact. In particular, this leads the pilot or the operator to change the current operation configuration of the aircraft.

For example, an abnormality detected at the elevator will encourage the pilot to modify the parameters of avionic systems responsible for the vertical position and the pitch axis of the aircraft.

This notably complicates the required cognitive load on the pilot of the aircraft. An abnormality having occurred during complex phases of the operation of the aircraft, such as the landing or take-off phases, sometimes makes it very delicate for the pilot to make an adequate decision, which considerably degrades the safety of the flight.

### SUMMARY OF CERTAIN INVENTIVE ASPECTS

An object of the certain embodiments is to propose a device and a method for assisting with the reconfiguration of the aircraft allowing reduction in the required cognitive load on the pilot for suitably acting, when confronted with an abnormality or a perturbation, and thus improving the safety of the flight.

For this purpose, an object of certain embodiments is a device for assisting with the reconfiguration of an aircraft of the aforementioned type, able to be connected between at least one monitoring system and at least one avionic system, and comprising:
a receiving module able to receive fault information from the monitoring system;
an impact computation module able to compute, depending on the received fault information, at least one impact on the operational configuration of the aircraft; and
a transmission module able to transmit the computed impact to at least one avionic system.

According to other aspects, the device for assisting with the reconfiguration of an aircraft comprises one or more of the following features, taken individually or according to all the technically possible combinations:
the transmission module includes a register of the subscriptions containing for each fault information, a list of one or more subscribed avionic systems;
the transmission module is able to transmit each computed impact to the sole avionic systems subscribed to the fault information corresponding to this impact;
each subscribed avionic system being able to evaluate said impact and to provide a result of this evaluation, and it further includes a reconfiguration module capable, for each computed impact, of receiving the evaluation result(s) of this impact from the corresponding avionic system(s), and of computing, depending on the received result(s), a new operational configuration of the aircraft allowing reduction of this impact;
the device further includes means for displaying each piece of fault information, the impact of the corresponding abnormality or perturbation on the current operational configuration of the aircraft, of the evaluation result(s) and of the new operational configuration of the aircraft allowing reduction of this impact; and
the impact computation module includes a database able to store a list of impacts caused by an abnormality or a given perturbation.

Another object of certain embodiments is also an aircraft having an operational configuration at a given instant, changing in an operational environment and including at least one avionic system, at least one avionic member, the avionic member being connected to at least one avionic system for piloting the aircraft and at least one monitoring system able to detect an abnormality of at least one avionic member or a perturbation of the operational environment and generate fault information relating to this abnormality or to this perturbation, the aircraft further including a device for assisting with the reconfiguration as defined above.

According to other aspects, the aircraft comprises one or more of the following features, taken individually or according to all the technically possible combinations:
each avionic system includes one or more of the following: a flight management system, an aircraft flight control system, an automatic pilot, an onboard airport navigation system, a traffic collision avoidance system, a terrain awareness and warning system, a communication management function, a radio management system, a weather radar and a traffic control system;
each monitoring system includes one or more of the following: a system for managing flight alerts, a system for monitoring traffic and a centralized maintenance system; and
each avionic member includes one or more of the following: a mechanical means for piloting or guiding the aircraft, an electronic actuator of at least one mechanical means, a propulsion means of the aircraft, wiring or tubing able to connect two elements from among mechanical means, electronic actuators and propulsion means, and a computer program able to apply at least one method for piloting and/or guiding the aircraft.

Another object of certain embodiments is a method for assisting with the reconfiguration of an aircraft, the aircraft having an operational configuration at a given instant, changing in an operational environment and including at least one avionic system, at least one avionic member, the avionic member being connected to at least one avionic system for piloting the aircraft and at least one monitoring system able to detect an abnormality of at least one avionic member or a perturbation of the operational environment and to generate fault information relating to this abnormality or to this perturbation;

the method being applied by a device for assisting reconfiguration able to be connected between at least one monitoring system, and at least one avionic system, and comprising the following steps:
receiving fault information from the monitoring system;
computing, depending on the received fault information, at least an impact on the operational configuration of the aircraft; and
transmitting the computed impact to at least one avionic system.

According to other aspects, the method for assisting with the reconfiguration of an aircraft further comprises the following steps:
subscribing at least one avionic system to at least one fault information, a list of one or more subscribed avionic systems being stored for each fault information in a register of subscriptions;
transmitting the computed impact to the sole subscribed avionic systems to the fault information corresponding to this impact;
for each computed impact, receiving evaluation result(s) of this impact from the corresponding avionic system(s); and
computing, depending on the received result(s), a new operational configuration of the aircraft allowing reduction of this impact.

Yet another object of certain embodiments is a computer program product including software instructions which, when applied by a piece of computer equipment, applies a method as defined above.

### BRIEF DESCRIPTION OF THE DRAWINGS

These characteristics and advantages of the described technology will become apparent upon reading the description which follows, only given as a non-limiting example, and made with reference to the appended drawings, wherein:

FIG. 1 is a schematic view of an aircraft according to an embodiment, the aircraft moving in an operational environment and including several avionic systems, several avionic members, each avionic member being connected to at least one avionic system for piloting the aircraft, several monitoring systems able to detect abnormalities of the avionic members or perturbations of the operational environment, and a device for assisting with reconfiguration;

FIG. 2 is a schematic view of the device for assisting with reconfiguration of FIG. 1, the device notably including a display screen and means for displaying data on the screen;

FIG. 3 is a schematic view of a dependency graph including a list of identifiers of avionic members of the aircraft of FIG. 1 which may cause an abnormality, which is then detected by one of the monitoring systems of FIG. 1;

FIG. 4 is a schematic view of a dependency graph including, for each abnormality or perturbation detected by one of the monitoring systems of FIG. 1, a list of impacts caused by this abnormality or perturbation;

FIG. 5 is a schematic view of a dependency graph including, for each computed impact, a list of new operational configurations of the aircraft of FIG. 1;

FIG. 6 is a schematic illustration of data displayed on the screen of FIG. 2;

FIG. 7 is a flowchart of a method for assisting reconfiguration according to an embodiment, the method for assisting reconfiguration being applied by the device of FIG. 2.

### DETAILED DESCRIPTION OF CERTAIN INVENTIVE ASPECTS

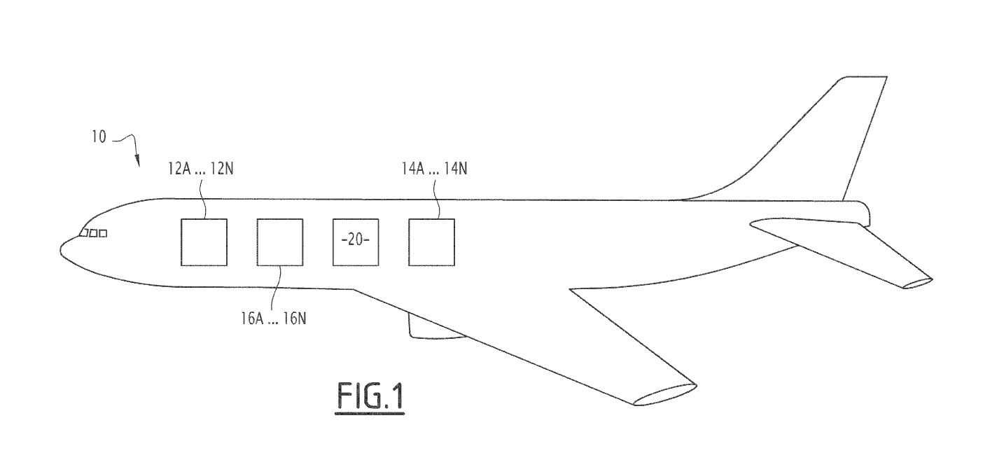

An aircraft 10 according to an embodiment is illustrated in FIG. 1. In the exemplary embodiment shown in this FIG. 1, the aircraft 10 is an airplane able to be operated by at least one pilot during its rated operation and by at least one technical operator during a maintenance operation on the ground. In the continuation of the description, the term “crew” generally refers to the pilot, or the maintenance operator, or further any other person operating the aircraft 10.

The aircraft 10 changes in an operational environment 18 and includes a plurality of avionic systems 12A to 12N each having a hardware or software means able to be directly or indirectly controlled by the crew, or further by another system for operating the aircraft 10.

When the aircraft 10 is an airplane, such an avionic system 12A to 12N is for example a flight management system (FMS), an aircraft flight control system (AFCS), an automatic pilot (AP), an onboard airport navigation system (OANS), a traffic collision avoidance system (TCAS), a terrain awareness and warning system (TAWS), a communication management function (CMF), a radio management system (RMS), a weather radar WXR (“Weather Radar”), or further a traffic control system TC.

The aircraft 10 further comprises a plurality of avionic members 14A to 14N each having hardware or software means intended to be used by at least one avionic system 12A to 12N for the purpose of operating the aircraft 10.

When the aircraft 10 is an airplane, such an avionic member 14A to 14N is for example a mechanical member for piloting or guiding the aircraft 10, an electronic actuator for at least one mechanical member, a propulsion member of the aircraft 10, wiring or tubing able to connect two elements from among mechanical members, electronic actuators, and propulsion members, or further a computer program able to apply at least one method for piloting and/or guiding the aircraft 10.

The aircraft 10 has an operational configuration OC at a given instant during its operation.

The aircraft 10 further comprises a plurality of monitoring systems 16A to 16N. Each monitoring system 16A to 16N is able to detect a perturbation of the operational environment 18 or an abnormality having occurred in at least one avionic member 14A to 14N and to generate fault information FI relating to this abnormality or perturbation.

Each abnormality is an event generated when an expected service is not provided by one or more corresponding avionic members 14A to 14N.

Each perturbation is an event generated when the operational environment of the aircraft changes in a non-compliant way with the initial mission of the aircraft.

When the aircraft 10 is an airplane, such a monitoring system 16A to 16N is for example a flight warning system (FWS) or a centralized maintenance system (CMS) or a traffic collision avoidance system (TCAS) and a terrain awareness and warning system (TAWS) or further, a weather radar (WXR).

Each fault information FI is for example in the form of a message including at least one identifier corresponding to the abnormality or to the detected perturbation. The whole of the abnormalities or perturbations is predetermined, and is provided for example by the aircraft manufacturer 10.

For example, when the aircraft 10 is an airplane, the fault information FI relating to a landing gear deployed during the ascension phase, includes an identifier corresponding to the atypical position of the deployed gear.

The aircraft 10 further includes a device 20 for assisting with the reconfiguration of the aircraft. The device 20 is connected between the monitoring systems 16A to 16N and the avionic systems 12A to 12N.

Each avionic system 12A to 12N is able to be connected to one or more avionic members 14A to 14N through connecting means, not shown. The connecting means for example comprises mechanical means able to transmit a mechanical signal and/or electric or radio-electric connections able to transmit an electric or radio-electric signal.

Each avionic system 12A to 12N is able to send instructions to one or more avionic members 14A to 14N via the connecting means.

The execution of each instruction by the avionic member 14A to 14N corresponding thereto allows this avionic member 14A to 14N to provide a service to the avionic system 12A to 12N having sent this instruction.

Each avionic system 12A to 12N includes a plurality of variable parameters able to be changed by the crew or by another avionic system 12A to 12N, in order to change the operation of this avionic system 12A to 12N.

Each avionic member 14A to 14N includes a plurality of variable parameters depending on an instruction of an avionic system 12A to 12N corresponding thereto in order to change the operation of this avionic member 12A to 12N.

The operational configuration OC of the aircraft 10 is then the whole of the parameters of the different avionic members 14A to 14N and systems 12A to 12N applied at the relevant instant.

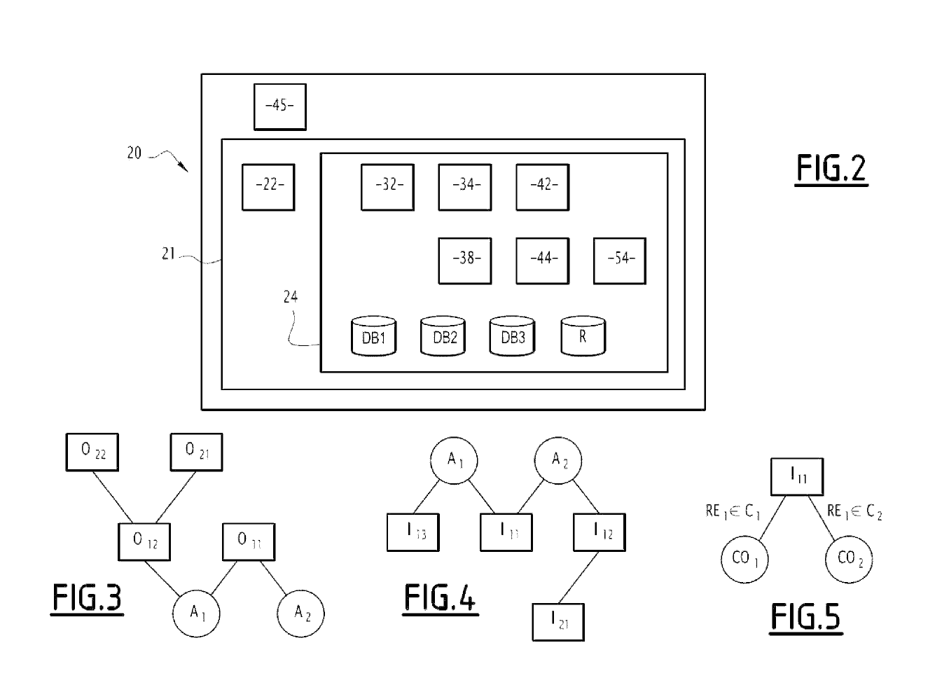

In FIG. 2, the device for assisting with reconfiguration 20 includes an information processing unit 21, for example formed with a processor 22 and a memory 24 associated with the processor 22.

The processor 22 is able to execute different software packages which the memory 24 is able to store.

The memory 24 is able to store a software package 32 for receiving fault information FI from the monitoring systems 16A to 16N.

The memory 24 is also able to store a software package 34 for computing at least one impact CI on the operational configuration OC of the aircraft 10. The computation software package 34 is desirably able to compute the impact(s) CI depending on the fault information FI received on behalf of the reception software package 32, the reception software package 32 then being able to transmit to the impact computation software package 34 the fault information FI received on behalf of the monitoring systems 16A to 16N. The impact computation software package 34 is able to determine, depending on the received fault information FI, at least one avionic member 14A to 14N which is at the origin of the abnormality corresponding to a given fault information FI.

The information relating to the origin of the abnormality is able to be used for example by the maintenance operator during a ground maintenance operation.

The memory 24 is also able to store a first database DB₁ including a list of identifiers of avionic members 14A to 14B which may cause a given abnormality. The first database DB₁ is for example formed by a dependency graph including for each known abnormality a list of identifiers of avionic members which may cause this abnormality. An example of such a graph is illustrated in FIG. 3.

As illustrated in this FIG. 3, an abnormality A₂ is caused by an avionic member having the identifier O₁₁. In the same figure, an abnormality A₁ is either caused by an avionic member having the identifier O₁₂, or by the member with the identifier O₁₁. On its side, an abnormality in the member with the identifier O₁₂ is either caused by an avionic member having the identifier O₂₂, or by an avionic member having the identifier O₂₁.

A computed impact CI for example corresponds to a change in the operation of the aircraft caused by an abnormality or a perturbation. For example, when the aircraft 10 is an airplane, an impact CI caused by the abnormality of the “deployed landing gear” type during the ascension phase is the increase in fuel consumption.

Alternatively, a computed impact CI for example corresponds to an operational limitation for one or more avionic members 14A to 14N caused by an abnormality. Such an operational limitation for example includes a restriction of a spectrum of accessible parameters for an avionic member 14A to 14N or an avionic system 12A to 12N. For example, when the aircraft 10 is an airplane, an operational limitation caused by an abnormality in the elevator implies for example limitations on a maximum accessible angle for pitching up of the airplane.

The memory 24 is able to further store a second database DB₂ including a list of impacts CI caused by a given abnormality. The second database DB₂ is for example formed by a dependency graph including, for each known abnormality, a list of impacts CI caused by this abnormality, as illustrated in FIG. 4.

In the example of FIG. 4, the abnormality A₁ has an impact I₁₃ and an impact I₁₁ . The abnormality A₂ has the same impact I₁₁ and another impact I₁₂. This last impact I₁₂ has further on its side an impact 1₂₁.

The memory 24 is able to further store a software package 38 for transmitting fault information FI and computed impacts CI to the avionic systems 12A to 12N. The transmission software package 38 is connected to the impact computation software package 34 and to the avionic systems 12A to 12N. The transmission software package 38 is able to establish a list of avionic systems 12A to 12N available in the aircraft 10. The transmission software package 38 is able to receive fault information FI and corresponding computed impacts CI, from the impact computation software package 34.

Additionally, the memory 24 is able to store a register of the subscriptions R containing, for each piece of fault information FI, a list of one or more avionic systems 12A to 12N subscribed to this fault information FI. Such as list of systems subscribed for each piece of fault information FI is desirably a predetermined list, for example by the manufacturer of the aircraft 10. This list notably contains the avionic systems 12A to 12N which may be impacted by a given abnormality or perturbation. The transmission software package 38 is then able to transmit each piece of fault information FI and the corresponding computed impact CI to the sole avionic systems 12A to 12N subscribed to this fault information FI.

Further additionally, each subscribed avionic system 12A to 12N is able to evaluate the received impact CI and to provide in return a result RE of this evaluation to the transmission software package 38. This evaluation result RE for example includes the impossibility of the system of accomplishing the current instruction introduced by the crew or by another avionic system 12A to 12N.

As an example, when the aircraft 10 is an airplane, a system subscribed to the fault information “deployed landing gear” is the flight management system FMS. This FMS system is able to receive this fault information FI with the computed impact CI corresponding to an increase in fuel consumption. The flight management system FMS is also able to evaluate this impact and to infer therefrom for example that the amount of fuel is insufficient for accomplishing the current instruction introduced by the crew. The flight management system FMS is then able to send the result of this evaluation “Insufficient Fuel X kg” to the transmission software package 38.

The memory 24 is able to further store a reconfiguration software package 42. The reconfiguration software package 42 is connected to the impact computation software package 34 and to the transmission software package 38. The reconfiguration software package 42 is able to receive each computed impact CI from the impact computation software package 34 and an evaluation result RE of this impact CI provided by each relevant avionic system 12A to 12N. The reconfiguration software package 42 is then able to compute, depending on the impact CI and on the received result(s) RE, a new operational configuration OC of the aircraft 10 allowing reduction of this impact.

The memory 24 is able to store a third database DB₃ for computing a new operational configuration OC of the aircraft 10. The third database DB₃ is for example formed by a dependency graph including for each computed impact CI a list of new operational configurations OC of the aircraft 10 allowing the induction of the computed impact CI by taking into account the received evaluation result(s) RE, as illustrated in FIG. 5.

In the example of FIG. 5, the computed impact I₁₁ is minimized by a new operational configuration OC₁ if an evaluation result RE₁ satisfies a condition C₁ and by a new operational configuration OC₂ if the evaluation result RE₁ satisfies a condition C₂. As an example, when the aircraft 10 is an airplane, the computed impact CI “increase in fuel consumption” subsequent to the abnormality “deployed landing gear” is reduced by selecting a closer destination than the one initially provided by the flight management system FMS subject to a sufficient fuel amount.

The memory 24 is able to further store a data display software package 44 on a screen 45 of the device for assisting reconfiguration, the display software package 44 being connected to the reconfiguration software package 42. The display software package 44 is able to display, intended for the crew of the aircraft, each piece of fault information FI, the computed impact CI of the corresponding abnormality on the current operational configuration OC of the aircraft 10, the corresponding evaluation result(s) RE and the new operational configuration OC of the aircraft 10 allowing reduction of the computed impact CI. The screen 45 is for example a touch screen.

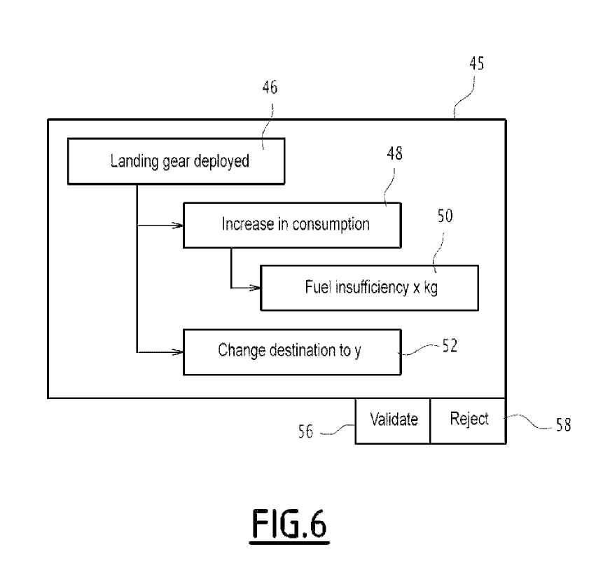

An example of display data by the display software package 44, when the aircraft 10 is an airplane, is shown in FIG. 6. In the example of FIG. 6, the display software package 44 is able to display a first message 46 corresponding to a detected abnormality or perturbation. The first message 46 for example corresponds to the abnormality “deployed landing gear”.

In the example of FIG. 6, the display software package 44 is able to display a second message 48 corresponding to an impact CI caused by the detected abnormality or perturbation. The second message 48 for example corresponds to the impact CI “increase in consumption”.

In the example of FIG. 6, the display software package 44 is able to display a third message 50 corresponding to at least one evaluation result RE provided by at least one avionic system 12A to 12N. The third message 50 for example corresponds to the result RE provided by the FMS system, “insufficient fuel X kg”.

In FIG. 6, the display software package 44 is able to display a fourth message 52 corresponding to a new operational configuration OC proposed by the reconfiguration module 42 allowing reduction of the computed impact CI. The fourth message 52 for example corresponds to a new operational configuration OC for the FMS system, “changing the destination for Y”.

Additionally, the memory 24 is able to store a control software package 54 connected to the display software package 44, to the reconfiguration software package 42 and to the avionic systems 12A to 12N. This control software package 54 is able to apply the new operational configuration OC found by the module 42 to the whole of the relevant avionic systems 12A to 12N after validation from the crew. In other words, the control software package 54 is able to send to the relevant avionic systems, the corresponding control signals for applying the new operational configuration OC. For this purpose, the device for assisting with reconfiguration 20 includes an actuating member 56 able to be controlled by the crew in order to apply the new operational configuration OC. The actuating member 56 is for example in the form of a tactile button displayed on the screen 45.

Alternatively, the receiving software package 32, the computation software package 34, the transmission software package 38, the reconfiguration software package 42, the display software package 44 and the control software package 54 are made in the form of programmable logic components, or further in the form of dedicated integrated circuits.

Additionally, the device for assisting with reconfiguration 20 includes a reset member 58. The reset member 58 is for example in the form of a tactile button displayed on the screen 45. Actuation of this reset member 58 by the crew gives the possibility of deleting the last new computed operational configuration OC and of controlling the reconfiguration software package 42 for computing another operational configuration OC.

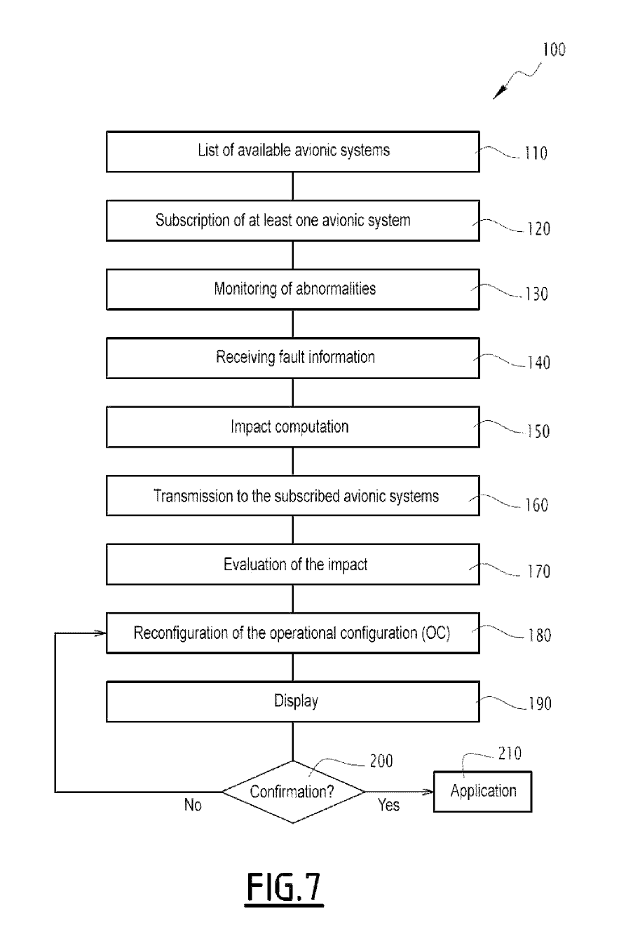

The operation of the device for assisting with reconfiguration 20 will now be explained by means of FIG. 7 illustrating a flowchart of a method 100 for assisting with reconfiguration according to an embodiment.

During an initial step 110, the transmission software package 38 establishes a list of all the avionic systems 12A to 12N available in the aircraft 10.

During step 120, each avionic system 12A to 12N from the list of available avionic systems is subscribed to at least one piece of fault information FI. The transmission software package 38 then generates a register of subscriptions R containing for each piece of fault information FI a list of identifiers of subscribed avionic systems 12A to 12N.

During step 130, the monitoring systems 16A to 16N monitor all the avionic members 14A to 14N. If these systems 16A to 16N detect at least one abnormality in the operation of the avionic members 12A to 12N or a perturbation of the environment 18, the system 16A to 16N generates a piece of fault information FI relating to this abnormality or to this perturbation.

If an abnormality or a perturbation was detected during step 130, the reception software package 32 receives a piece of fault information FI relating to this abnormality or to this perturbation during step 140.

During step 150, the reception software package 32 transmits the piece of fault information FI to the impact computation software package 34. The impact computation software package 34 also determines one or several avionic members 14A to 14N at the origin of the abnormality or of the perturbation corresponding to the piece of received fault information FI. This determination is carried out by means of the first database DB₁.

In this same step 150, the impact computation software package 34 computes an impact CI on the current operational configuration OC of the aircraft 10. This computation is carried out by means of the second database DB₂. The impact computation software package 34 then transmits the piece of fault information FI and the computed impact CI to the transmission software package 38 and to the reconfiguration software package 42.

During step 160, the transmission software package 38 transmits the piece of fault information FI and the computed impact CI to the sole subscribed systems to this piece of fault information FI, a list of identifiers of systems subscribed to this fault information FI being stored in the register of subscriptions R.

During step 170, each avionic system 12A to 12N having received said computed impact CI evaluates this impact and transmits the result RE of this evaluation to the transmission software package 38. The transmission software package 38 also transmits each evaluation result RE to the reconfiguration software package 42.

During step 180, for each computed impact CI, the reconfiguration software package 42 determines a new operational configuration OC of the aircraft 10 by taking into account the evaluation result(s) RE received from the subscribed avionic systems. This determination is carried out by means of the third database DB₃.

During the step 190, the reconfiguration software package 42 transmits the piece of fault information FI, the computed impact CI, the evaluation result(s) RE from the subscribed avionic systems and the new operational configuration OC. The display software package 44 displays on the display screen 45 the piece of fault information FI, the computed impact CI, the result(s) RE of this impact and the new operational configuration OC.

If the crew confirms, during step 200 and by means of the actuation member 56, the displayed operational configuration OC, this operational configuration OC is applied to the whole of the relevant avionic systems 12A to 12N by the control software package 54 during the next step 210.

During step 200, if the crew rejects by means of the reset member 58 the displayed operational configuration OC, the software package 45 returns to step 180 so that the reconfiguration software package 42 computes another operational configuration OC.

The device for assisting with reconfiguration 20 allows the crew of the aircraft 10 to see the impact of an abnormality having occurred in an avionic member 14A to 14N or of a perturbation of the operational environment 18 on the operational configuration OC of the aircraft 10 and thus assists the crew with selection of a suitable action.

Further, the device for assisting reconfiguration 20 computes at least one new operational configuration OC of the aircraft 10 allowing reduction of this impact. The new operational configuration OC is easily applicable to the whole of the relevant avionic systems, for example by simply actuating the actuation member 56.

Thus, with the device for assisting reconfiguration 20, the crew of the aircraft 10 no longer needs to perform impact computations manually, or manually change the operational configuration OC of the aircraft 10, this being carried out automatically by the device for assisting with reconfiguration 20. This therefore considerably reduces the required cognitive load on the crew which allows them to act in a more suitable way when confronted with an abnormality or a perturbation, and also to improve the safety of the flight.

As can be appreciated by one of ordinary skill in the art, each of the modules or software of the program(s) can include various sub-routines, procedures, definitional statements, and macros. Each of the modules are typically separately compiled and linked into a single executable program. Therefore, any description of modules or software is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. A device for assisting with reconfiguration of an aircraft, the aircraft having an operational configuration at a given instant, configured to move in an operational environment and including i) at least one avionic system, ii) at least one avionic member, the avionic member being connected to the avionic system for piloting the aircraft, and iii) at least one monitoring system configured to detect an abnormality of the avionic member or a perturbation of the operational environment and to generate fault information relating to the abnormality or to the perturbation,
the device being connected between the monitoring system and the avionic system, the device comprising:
a reception module configured to receive the fault information from the monitoring system;
an impact computation module configured to compute, depending on the received fault information, at least one impact on the operational configuration of the aircraft; and
a transmission module configured to transmit the computed impact to the avionic system.

2. The device according to claim 1, wherein:
the transmission module includes a register of subscriptions, wherein each piece of fault information is subscribed to a list of one or more avionic systems; and
the transmission module is configured to transmit each of the computed impacts to the avionic systems subscribed to the piece of fault information corresponding to the computed impact.

3. The device according to claim 2, wherein each of the subscribed avionic systems is configured to evaluate the computed impact and to provide a result of this evaluation, wherein the device further includes a reconfiguration module configured to, for each computed impact:
receive the evaluation result(s) of the computed impact from the corresponding avionic system(s); and
compute, depending on the received result(s), a new operational configuration of the aircraft allowing reduction of the computed impact.

4. The device according to claim 3, further including a screen configured to display each piece of fault information, the impact of the corresponding abnormality or perturbation on the current operational configuration of the aircraft, the evaluation result(s) and the new operational configuration of the aircraft allowing reduction of this impact.

5. The device according to claim 1, wherein the impact computation module includes a database configured to store a list of impacts caused by a given abnormality or a perturbation.

6. An aircraft having an operational configuration at a given instant and configured to move in an operational environment, the aircraft comprising:
at least one avionic system;
at least one avionic member, the avionic member being connected to the avionic system for piloting the aircraft;
at least one monitoring system configured to i) detect an abnormality of the avionic member or a perturbation of the operational environment and ii) generate fault information relating to the abnormality or to the perturbation; and
a device configured to assist with reconfiguration of the aircraft, the device comprising:
a reception module configured to receive the fault information from the monitoring system;
an impact computation module configured to compute, depending on the received fault information, at least one impact on the operational configuration of the aircraft; and
a transmission module configured to transmit the computed impact to the avionic system.

7. The aircraft according to claim 6, wherein the avionic system includes one or more of the following: a flight management system, an aircraft flight control system, an automatic pilot, an onboard airport navigation system, a traffic collision avoidance system, a terrain awareness and warning system, a communication management function, a radio management system, a weather radar and a traffic control system.

8. The aircraft according to claim 6, wherein each monitoring system includes one or more of the following: a flight warning system, a traffic avoidance warning system and a centralized maintenance system.

9. The aircraft according to claim 6, wherein each avionic member includes one or more of the following: a mechanical means for piloting or guiding the aircraft, an electronic actuator for at least one mechanical means, a propulsion means of the aircraft, wiring or tubing able to connect two elements from among mechanical means, electronic actuators, and propulsion means and a computer program able to apply at least one method for piloting and/or guiding the aircraft.

10. A method for assisting with reconfiguration of an aircraft, the aircraft having an operational configuration at a given instant and including i) at least one avionic system, ii) at least one avionic member, the avionic member being connected to the avionic system for piloting the aircraft, and iii) at least one monitoring system configured to detect an abnormality of the avionic member or a perturbation of the operational environment and generate fault information relating to the abnormality or to the perturbation,
the method being performed by a device for assisting reconfiguration, wherein the device is connected between the monitoring system and the avionic system and wherein the method comprises:
receiving the fault information from the monitoring system;
computing, depending on the received fault information, at least one impact on the operational configuration of the aircraft; and
transmitting the computed impact to the avionic system.

11. The method according to claim 10, further comprising:
subscribing a list of one or several avionic systems to at least one piece of fault information, wherein the list is stored for each piece of fault information in a register of subscriptions; and
transmitting the computed impact to the avionic systems subscribed to the piece of fault information corresponding to the computed impact.

12. The method according to claim 11, further comprising:
for each computed impact, receiving evaluation result(s) of the computed impact from the corresponding avionic system(s); and
computing, depending on the received result(s), a new operational configuration of the aircraft allowing reduction of the computed impact.

13. A computer program product including software instructions for assisting with reconfiguration of an aircraft, the aircraft having an operational configuration at a given instant and including i) at least one avionic system, ii) at least one avionic member, the avionic member being connected to the avionic system for piloting the aircraft, and iii) at least one monitoring system configured to detect an abnormality of the avionic member or a perturbation of the operational environment and generate fault information relating to the abnormality or to the perturbation, wherein when the software instructions are executed by a processor, the software instructions cause the processor to perform a method comprising:
receiving the fault information from the monitoring system;
computing, depending on the received fault information, at least one impact on the operational configuration of the aircraft; and
transmitting the computed impact to the avionic system.
